(19) United States
(12) Patent Application Publication
(10) Pub. No.: US 2023/0252283 A1
(43) Pub. Date: Aug. 10, 2023

(54) METHOD AND DEVICE WITH NEURAL NETWORK

(71) Applicant: SAMSUNG ELECTRONICS CO., LTD., Suwon-si (KR)

(72) Inventors: Jaeyun LEE, Suwon-si (KR); Kiho CHO, Gunpo-si (KR); Jiwhan KIM, Suwon-si (KR); Sungun PARK, Suwon-si (KR); Jaejoon HAN, Seoul (KR)

(73) Assignee: SAMSUNG ELECTRONICS CO., LTD., Suwon-si (KR)

(21) Appl. No.: 17/982,618

(22) Filed: Nov. 8, 2022

(30) Foreign Application Priority Data
Feb. 7, 2022 (KR) 10-2022-0015462
Apr. 1, 2022 (KR) 10-2022-0041081

(51) Int. Cl. G06N 3/08

(52) U.S. Cl. CPC G06N 3/08

(57) ABSTRACT

A processor-implemented method with a neural network includes: generating a first intermediate vector by applying a first activation function to first nodes in a first intermediate layer adjacent to an input layer among intermediate layers of the neural network; transferring the first intermediate vector to second nodes in a second intermediate layer adjacent to an output layer among the intermediate layers; generating a second intermediate vector by applying a second activation function to the second nodes; and applying the second intermediate vector to an output layer of the neural network, wherein the second activation function is determined by a first hyperparameter of which a multiplier of the second activation function is associated with an ascending slope of the second activation function and a second hyperparameter of which the multiplier is associated with a descending slope of the second activation function to fix a peak value of the second activation function.

### CROSS-REFERENCE TO RELATED APPLICATIONS

This application claims the benefit under 35 USC § 119(a) of Korean Patent Application No. 10-2022-0015462 filed on Feb. 7, 2022, and Korean Patent Application No. 10-2022-0041081 filed on Apr. 1, 2022, in the Korean Intellectual Property Office, the entire disclosure of which is incorporated herein by reference for all purposes.

### BACKGROUND

### 1. Field

The following description relates to a method and a device with a neural network.

### 2. Description of Related Art

A neural network may be a component for machine learning. Assuming a probability distribution of parameters of the neural network may induce a distribution from an input to an output of the neural network. Although a user may desire a more flexible modeling of the neural network, the neural network may not determine an accurate result from an area for which the neural network is not yet trained.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method with a neural network includes: generating a first intermediate vector by applying a first activation function to first nodes in a first intermediate layer adjacent to an input layer among intermediate layers of the neural network; transferring the first intermediate vector to second nodes in a second intermediate layer adjacent to an output layer among the intermediate layers; generating a second intermediate vector by applying a second activation function to the second nodes; and applying the second intermediate vector to an output layer of the neural network, wherein the second activation function is determined by a first hyperparameter of which a multiplier of the second activation function is associated with an ascending slope of the second activation function and a second hyperparameter of which the multiplier is associated with a descending slope of the second activation function to fix a peak value of the second activation function.

A dynamic range of the second activation function may be from a value of 0 to a value of 1.

The second activation function may be represented as σ(x) and may be represented by the following equation:

$$σ ( x ) = {( \frac{eb}{a} )}^{a} {x}^{a} exp ( - bx ) Θ ( x ) ,$$

wherein a denotes the first hyperparameter associated with the ascending slope of the second activation function, b denotes the second hyperparameter associated with the descending slope of the second activation function, e denotes Euler's number, x denotes an input of the second nodes, and Θ(x) denotes a Heaviside step function that allows an output of the second activation function to be 0 when x is less than 0.

The first activation function may include any one or any combination of any two or more of a step function, a sigmoid function, a hyperbolic tangent function, a rectified linear unit (ReLU) function, and a leaky ReLU function.

The neural network may include any one or any combination of any two or more of a convolutional neural network (CNN), a deep neural network (DNN), and a recurrent neural network (RNN).

The neural network may be a trained neural network, and the training of the neural network may include: extracting a first result value by applying the first activation function to intermediate nodes comprised in each of the intermediate layers; extracting a second result value by applying the second activation to additional nodes connected to intermediate nodes in one or more of the intermediate layers; and training the neural network based on a difference between the first result value and the second result value.

The first intermediate may be is generated based on training data input, and the method may include: performing primary training on the neural network based on a difference between the first intermediate vector and a ground truth vector corresponding to the training data; and performing the secondary training on the primary trained neural network based on a difference between an output value output through the output layer from the second intermediate vector and a ground truth value corresponding to the training data.

The method may include: detecting a first spoofing detection result of biometric information by determining a first score based on the first intermediate vector; determining, in response to the first spoofing detection result being detected, a second score based on a result of the applying of the second intermediate vector to the output layer; and detecting a second spoofing detection result of the biometric information by a score in which the first score and the second score are combined.

In another general aspect, one or more embodiments include a non-transitory computer-readable storage medium storing instructions that, when executed by one or more processors, configure the one or more processors to perform any one, any combination, or all operations and methods described herein.

In another general aspect, a processor-implemented method with a neural network includes: extracting a first result value by applying a first activation function to intermediate nodes comprised in each of intermediate layers of the neural network; extracting a second result value by applying a second activation function different from the first activation function to additional nodes connected to intermediate nodes in one or more of the intermediate layers; and training the neural network based on a difference between the first result value and the second result value.

The second activation function may be determined by a first hyperparameter of which a multiplier of the second activation function is associated with an ascending slope of the second activation function and a second hyperparameter of which the multiplier is associated with a descending slope of the second activation function to fix a peak value of the second activation function.

A total number of the additional nodes may be one less than a total number of the intermediate nodes, and the additional nodes and the intermediate nodes may be fully connected.

The second activation function may be represented as σ(x) may be is represented by the following equation:

$$σ ( x ) = {( \frac{eb}{a} )}^{a} {x}^{a} exp ( - bx ) Θ ( x ) ,$$

wherein a denotes a first hyperparameter associated with an ascending slope of the second activation function, b denotes a second hyperparameter associated with a descending slope of the second activation function, e denotes Euler's number, x denotes an input of the additional nodes, and Θ(x) denotes a Heaviside step function that allows an output of the second activation function to be 0 when x is less than 0.

A dynamic range of the second activation function may be from a value of 0 to a value of 1.

The first activation function may include any one or any combination of any two or more of a step function, a sigmoid function, a hyperbolic tangent function, a rectified linear unit (ReLU) function, and a leaky ReLU function.

In another general aspect, a processor-implemented method with a neural network includes: generating a first feature vector by propagating training data input to an input layer of the neural network to first nodes that are included in a first intermediate layer adjacent to the input layer among intermediate layers of the neural network and that operate according to a first activation function; performing primary training on the neural network based on a difference between the first feature vector and a ground truth vector corresponding to the training data; generating a second feature vector by propagating the first feature vector to second nodes that are included in a second intermediate layer adjacent to an output layer among the intermediate layers of the primary trained neural network; and performing secondary training on the primary trained neural network based on a difference between an output value output through the output layer from the second feature vector and a ground truth value corresponding to the training data.

The second activation function may be determined by a first hyperparameter of which a multiplier of the second activation function is associated with an ascending slope of the second activation function and a second hyperparameter of which the multiplier is associated with a descending slope of the second activation function to fix a peak value of the second activation function.

The second activation function may be represented as σ(x) and may be represented by the following equation:

$$σ ( x ) = {( \frac{eb}{a} )}^{a} {x}^{a} exp ( - bx ) Θ ( x ) ,$$

wherein a denotes a first hyperparameter associated with an ascending slope of the second activation function, b denotes a second hyperparameter associated with a descending slope of the second activation function, e denotes Euler's number, x denotes the second feature vector, and Θ(x) denotes a Heaviside step function that allows an output of the second activation function to be 0 when x is less than 0.

Adynamic range of the second activation function may be from a value of 0 to a value of 1.

The first activation function may include any one or any combination of any two or more of a step function, a sigmoid function, a hyperbolic tangent function, a rectified linear unit (ReLU) function, and a leaky ReLU function.

In another general aspect, a processor-implemented method with a neural network includes: extracting one or more first feature vectors from a plurality of intermediate layers of the neural network that detects whether biometric information is spoofed from input data comprising the biometric information of a user, using one or more pre-trained first classifiers; detecting a first spoofing detection result of the biometric information by determining a first score based on the one or more first feature vectors; determining, in response to the first spoofing detection result being detected, a second score by applying, to a pre-trained second classifier, an output vector output from an output layer of the neural network; and detecting a second spoofing detection result of the biometric information by a score in which the first score and the second score are combined, wherein either one or both of the first classifiers and the second classifier is trained by an activation function that is determined by a first hyperparameter of which a multiplier of the activation function is associated with an ascending slope of the activation function and a second hyperparameter of which the multiplier is associated with a descending slope of the activation function to fix a peak value of the activation function for the neural network.

A dynamic range of the activation function may be from a value of 0 to a value of 1.

The activation function may be represented as σ(x) and may be represented by the following equation:

$$σ ( x ) = {( \frac{eb}{a} )}^{a} {x}^{a} exp ( - bx ) Θ ( x ) ,$$

wherein a denotes the first hyperparameter associated with the ascending slope of the activation function, b denotes the second hyperparameter associated with the descending slope of the activation function, e denotes Euler's number, x denotes the input data, and Θ(x) denotes a Heaviside step function that allows an output of the activation function to be 0 when x is less than 0.

The extracting of the one or more first feature vectors may include: extracting a feature vector from a first intermediate layer among the intermediate layers using a classifier among the first classifiers; extracting another feature vector from a second intermediate layer following the first intermediate layer using another classifier among the first classifiers; and extracting a combined feature vector in which the feature vector and the other feature vector are combined.

The detecting of the first spoofing detection result of the biometric information may include: determining the first score based on a similarity between the combined feature vector and either one or both of a registered feature vector and a spoofed feature vector that is provided in advance; and classifying the first score into a score determined to be spoofed information or a score determined to be ground truth information, using the first classifiers.

The biometric information may include any one or any combination of any two or more of a fingerprint, an iris, and a face of the user.

In another general aspect, an electronic device with a neural network includes: a sensor configured to capture input data comprising biometric information of a user; one or more processors configured to: extract one or more first feature vectors from a plurality of intermediate layers of the neural network configured to detect whether biometric information is spoofed from the input data, using one or more pre-trained first classifiers; detect a first spoofing detection result of the biometric information by determining a first score based on the one or more first feature vectors; determine, in response to the first spoofing detection result being detected, a second score by applying an output vector output from an output layer of the neural network to a pre-trained second classifier; and detect a second spoofing detection result of the biometric information by a score in which the first score and the second score are combined; and an output device configured to output either one or both of the first spoofing detection result and the second spoofing detection result, wherein either one or both of the first classifiers and the second classifier is trained based on an activation function that is determined by a first hyperparameter of which a multiplier of the activation function is associated with an ascending slope of the activation function and a second hyperparameter of which the multiplier is associated with a descending slope of the activation function to fix a peak value of the activation function for the neural network.

The activation function may be represented as σ(x) and may be represented by the following equation:

$$σ ( x ) = {( \frac{eb}{a} )}^{a} {x}^{a} exp ( - bx ) Θ ( x ) ,$$

wherein a denotes the first hyperparameter associated with the ascending slope of the activation function, b denotes the second hyperparameter associated with the descending slope of the activation function, e denotes Euler's number, x denotes an input of additional nodes, and Θ(x) denotes a Heaviside step function that allows an output of the activation function to be 0 when x is less than 0.

In another general aspect, a processor-implemented method with a neural network includes: performing first spoofing detection by determining a first score based on one or more first feature vectors generated using a first intermediate layer of the neural network based on input data; determining whether to perform second spoofing detection, based on the first score; and, in response to determining to perform the second spoofing detection, determining a second score based on an output vector generated by an output layer of the neural network based on the one or more first feature vectors; and performing the second spoofing detection based on a score in which the first score and the second score are combined.

The one or more first feature vectors may be generated by applying input data to a first activation function of the first intermediate layer, and the determining of the second score may include: generating one or more second feature vectors by applying the one or more first feature vectors to a second activation function of a second intermediate layer, wherein one or more intermediate layers are disposed between the first intermediate layer and the second intermediate layer; and generating the output vector based on the one or more second feature vectors, using the output layer.

A dynamic range of an output of the second activation function may be less than the first activation function.

The determining of whether to perform the second spoofing detection may include: determining not to perform the second spoofing detection in response to the first score being within a predetermined threshold value range; and determining to perform the second spoofing detection in response to the first score being outside the predetermined threshold value range.

Other features and aspects will be apparent from the following detailed description, the drawings, and the claims.

### BRIEF DESCRIPTION OF THE DRAWINGS

FIG. 1 is a diagram illustrating an example of an environment where an electronic device including a neural network is used.

FIG. 2 is a flowchart illustrating an example of a method of operating a neural network.

FIG. 3 is a diagram illustrating an example of a structure of a neural network.

FIG. 4 is a diagram illustrating an example of an area discriminating between spoofed information and live information by a neural network.

FIG. 5 is a diagram illustrating an example of an activation function applied to each layer of a neural network.

FIG. 6 is a flowchart illustrating an example of a training method of a neural network.

FIG. 7 is a diagram illustrating an example of a training method.

FIG. 8 is a flowchart illustrating an example of a training method of a neural network.

FIG. 9 is a diagram illustrating an example of a training method.

FIG. 10 is a flowchart illustrating an example of a method of detecting whether biometric information is spoofed using a neural network.

FIG. 11 is a diagram illustrating an example of a structure and operation of a neural network.

FIG. 12 is a diagram illustrating an example of an electronic device configured to detect whether biometric information is spoofed using a neural network.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known, after an understanding of the disclosure of this application, may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween. Likewise, similar expressions, for example, “between” and “immediately between,” and “adjacent to” and “immediately adjacent to,” are also to be construed in the same way. As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

Also, in the description of example embodiments, detailed description of structures or functions that are thereby known after an understanding of the disclosure of the present application will be omitted when it is deemed that such description will cause ambiguous interpretation of the example embodiments. Hereinafter, examples will be described in detail with reference to the accompanying drawings, and like reference numerals in the drawings refer to like elements throughout.

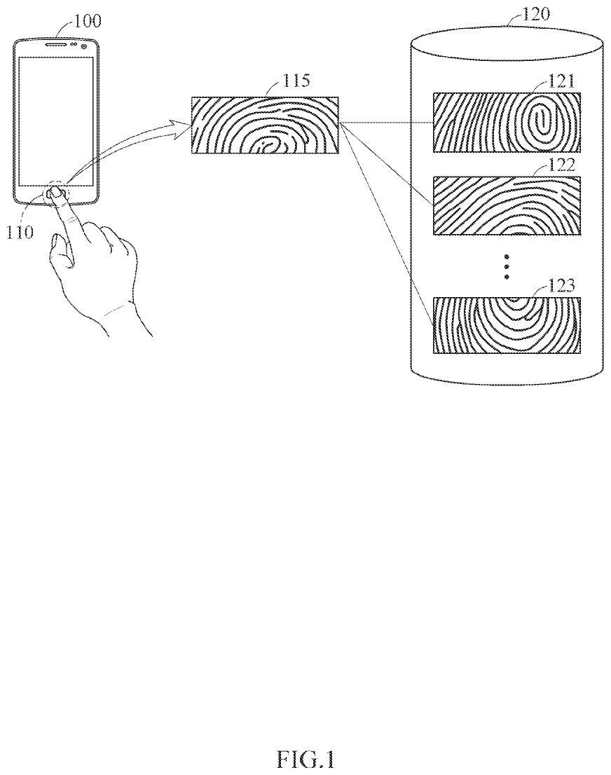

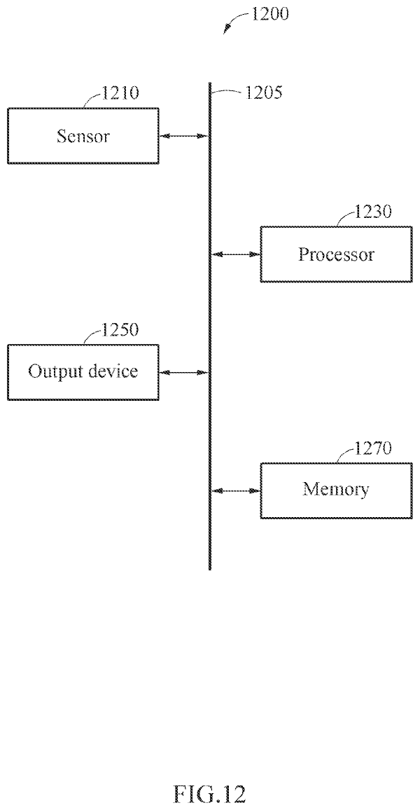

FIG. 1 is a diagram illustrating an example of an environment where an electronic device including a neural network is used. In an example of FIG. 1, illustrated are an electronic device 100 including a sensor 110 (e.g., one or more sensors) configured to sense biometric information (e.g., fingerprints) of a user, and a registered fingerprint database (DB) 120 including registered fingerprint images 121, 122, and 123. Hereinafter, fingerprint images will be described as an example of biometric information of a user for the convenience of description, but examples of the biometric information are not limited thereto. The biometric information may include various sets of information, for example, iris images, palm line images, face images, and/or the like. The electronic device 100 may be, include, or be included in an electronic device 1200 of FIG. 12, as a non-limiting example.

The electronic device 100 may obtain (e.g., determine) an input fingerprint image 115 including a fingerprint of the user through the sensor 110. The sensor 110 may be, as non-limiting examples, an ultrasonic fingerprint sensor, an optical fingerprint sensor, a capacitive fingerprint sensor, and/or an image sensor that is configured to capture an image of a fingerprint of a user. The sensor 110 may be, include, or be included in a sensor 1210 of FIG. 12, as a non-limiting example.

For fingerprint recognition, fingerprint registration may be performed. Through the fingerprint registration, the registered fingerprint images 121, 122, and 123 may be stored in advance in the registered fingerprint DB 120. In a non-limiting example, to protect personal information, the registered fingerprint DB 120 may store therein features or feature vectors extracted from the registered fingerprint images 121, 122, and 123, rather than storing the registered fingerprint images 121, 122, and 123 as they are. The registered fingerprint DB 120 may be stored in a memory (e.g., a memory 1270 of FIG. 12) included in the electronic device 100 or in an external device such as a server, a local cache, or a cloud server that communicates with the electronic device 100.

When the input fingerprint image 115 is received for authentication, the electronic device 100 may authenticate the user of the input fingerprint image 115 and/or detect whether the input fingerprint image 115 is spoofed or not, based on a similarity between an input fingerprint included in the input fingerprint image 115 and registered fingerprints included in the registered fingerprint images 121, 122, and 123. The term “spoofing” or “spoofed” used herein may indicate fake biometric information, which is not live or real biometric information, and may be construed as encompassing copying, forging, altering, and/or the like.

As to be described in detail later, the electronic device 100 may determine whether to authenticate the input fingerprint or determine whether the input fingerprint is spoofed, using an unspecified number of provided live (or real) fingerprint features, spoofed (or fake) fingerprint features, and/or registered fingerprint features of a user of the electronic device 100.

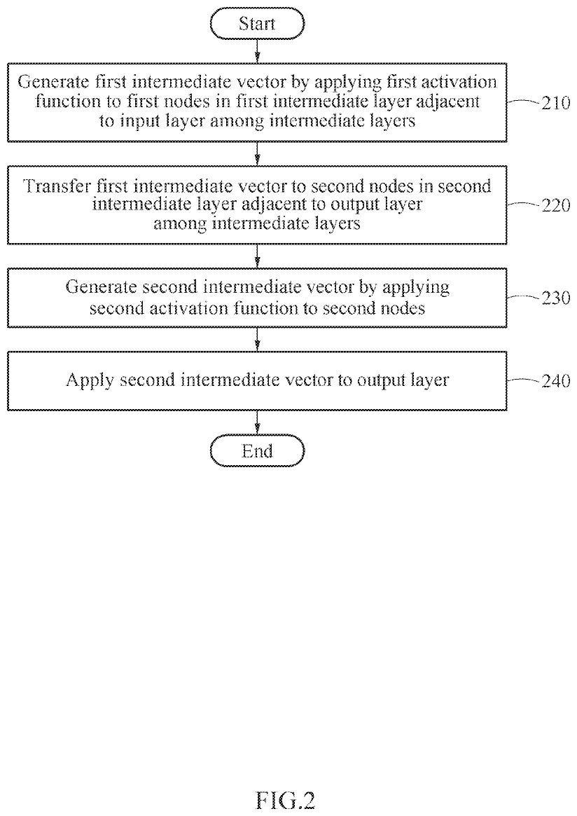

FIG. 2 is a flowchart illustrating an example of a method of operating a neural network. The operations of FIG. 2 to be described hereinafter may be performed in sequential order but may not be necessarily performed in sequential order. For example, the order of the operations may be changed, and at least two of the operations may be performed in parallel or simultaneously. Further, one or more of the operations may be omitted, without departing from the spirit and scope of the shown example. One or more blocks of FIG. 2, and combinations of the blocks, may be implemented by special purpose hardware-based computer that perform the specified functions, or combinations of special purpose hardware and instructions, e.g., computer or processor instructions. In addition to the description of FIG. 2 below, the description of FIG. 1 is also applicable to FIG. 2 and is incorporated herein by reference. Thus, the above description may not be repeated here for brevity purposes.

Referring to FIG. 2, a neural network including an input layer, a plurality of intermediate layers, and an output layer may perform operations 210 through 240 to be described hereinafter. The neural network may include, for example, either one or both of a convolutional neural network (CNN) and a deep neural network (DNN), but is not limited thereto.

In operation 210, the neural network may generate a first intermediate vector by applying a first activation function to first nodes included in a first intermediate layer adjacent to the input layer among the intermediate layers. In an example, the first intermediate layer may apply the first activation function to inputs of the first nodes, where the inputs are outputs of the input later. The first activation function may include, for example, any one or any combination of any two or more of a step function, a sigmoid function, a hyperbolic tangent function, a rectified linear unit (ReLU) function, and a leaky ReLU function, but examples of which are not limited thereto.

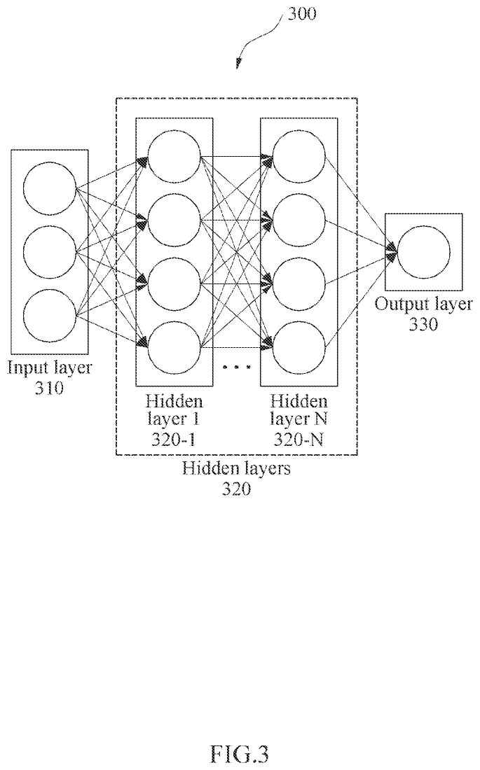

non-limiting examples of a structure and operations of the neural network will be described in greater detail with reference to FIGS. 3 through 5.

In operation 220, the neural network may transfer the first intermediate vector to second nodes included in a second intermediate layer adjacent to the output layer among the intermediate layers.

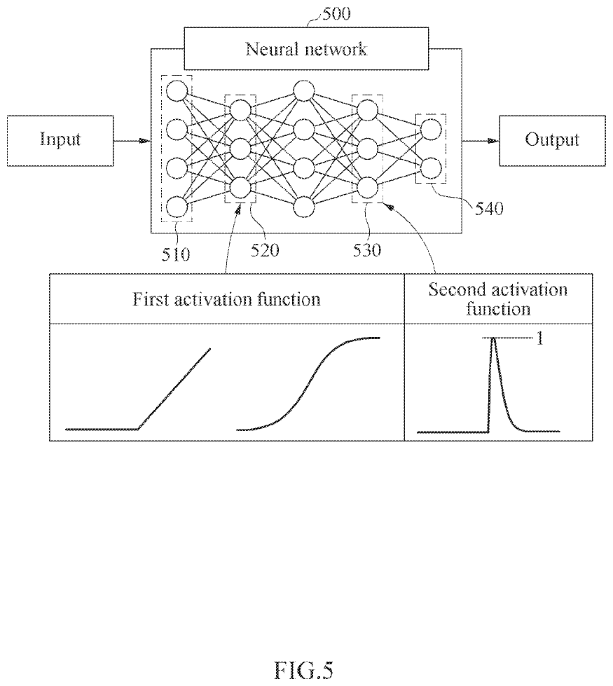

In operation 230, the neural network may generate a second intermediate vector by applying a second activation function to the second nodes. In an example, the second intermediate layer may apply the second activation function to inputs of the second nodes, where the inputs are outputs of an intermediate layer between the first intermediate layer and the second intermediate layer. A non-limiting example of the second activation function will be described in detail with reference to FIG. 5.

In operation 240, the neural network may apply the second intermediate vector to the output layer.

FIG. 3 is a diagram illustrating an example of a structure of a neural network.

In the example of FIG. 3, a structure of a DNN 300 is schematically illustrated. The DNN 300 may be trained through deep learning.

The DNN 300 may include a plurality of layers 310, 320, and 330 each including a plurality of nodes. The DNN 300 may include connection weights that connect nodes included in each of the layers 310, 320, and 330 to nodes included in another one of the layers 310, 320, and 330. An electronic device may obtain the DNN 300 from an internal DB stored in a memory (e.g., a memory 1270 of FIG. 12), or obtain the DNN 300 by receiving it from an external server through an output device (e.g., an output device 1250 of FIG. 12).

For example, the DNN 300 may include numerous nodes connected by linear edges. A node is illustrated as a circle in FIG. 3. The nodes may be mutually connected through edges having connection weights. A connection weight may be a specific value of edges and may also be referred to as a synapse weight or a connection intensity.

The DNN 300 may include an input layer 310, hidden layers 320 (e.g., intermediate layers), and an output layer 330. The input layer 310, the hidden layers 320, and the output layer 330 may each include a plurality of nodes. The nodes included in the input layer 310 may be referred to as input nodes, and the nodes included in the hidden layers 320 may be referred to as hidden nodes. The hidden layers 320 may also be referred to as intermediate layers in that the hidden layers 320 are disposed in the middle the input layer 310 and the output layer 330. A hidden layer and an intermediate layer to be described hereinafter may thus be construed as the same.

The nodes included in the output layer 330 may be referred to as output nodes.

The input layer 310 may receive input data for performing training and/or recognition, and may transfer the received input data to hidden layer 1 320-1 of the hidden layers 320 (e.g., the first intermediate layer). The output layer 330 may generate an output of the DNN 300 based on a signal received from hidden layer N 320-N of the hidden layers 320 (e.g., the second intermediate layer). The hidden layers 320 may be disposed between the input layer 310 and the output layer 330 and change a training input of training data transferred through the input layer 310 to a predictable value. The input nodes included in the input layer 310 and the hidden nodes included in the hidden layer 1 320-1 the hidden layers 320 may be connected to each other through connecting lines having a connection weight. The hidden nodes included in the hidden layer N 320-N of the hidden layers 320 and the output nodes included in the output layer 330 may be connected to each other through connecting lines having a connection weight.

The hidden layers 320 may include a plurality of layers (e.g., the hidden layer 1 320-1 through the hidden layer N 320-N). For example, when the hidden layer 320 includes a first hidden layer, a second hidden layer, and a third hidden layer, an output of a hidden node included in the first hidden layer may be connected to hidden nodes included in the second hidden layer, and an output of a hidden node included in the second hidden layer may be connected to hidden nodes included in the third hidden layer.

For example, the electronic device may input outputs of preceding hidden nodes included in a preceding hidden layer to a corresponding hidden layer through connecting lines having a connection weight. In this example, the electronic device may generate an output of hidden nodes included in the hidden layer based on values obtained by applying the connection weight to the outputs of the preceding hidden nodes and on an activation function. When a result of the activation function exceeds a threshold value of a current hidden node, a corresponding output may be transferred to a following hidden node. In this case, the current hidden node may remain inactivated without transferring a signal to the following hidden node until the output reaches a specific threshold activation intensity through input vectors.

The electronic device may train the DNN 300 through supervised learning. The electronic device may be implemented by a hardware module or a combination of a hardware module implementing a software module. The supervised learning may refer to a method of inputting, to the DNN 300, both a training input of training data and a corresponding training output of the training data, and updating a connection weight of connecting lines such that output data corresponding to the training output is output. The training data may refer to data including a pair of the training input and the training output.

Although the structure of the DNN 300 is illustrated as a node structure in FIG. 3, examples of the structure are not limited to such a node structure and various data structures may be used to store a neural network in a memory.

For the supervised learning, the electronic device may determine a parameter of the nodes included in the DNN 300 through a gradient descent method that is based on a loss backpropagated to the DNN 300 and an output value of the nodes included in the DNN 300.

For example, the electronic device may update the connection weight between the nodes through loss backpropagation learning. The loss backpropagation learning may refer to a method that estimates a loss through forward computation on given training data and then updates a connection weight in a direction that may reduce the loss while propagating the estimated loss in an inverse direction starting from the output layer 330 toward the input layer 310 through the hidden layers 320.

Although processing by the DNN 300 is performed in a direction from the input layer 310 to the output layer 330 through the hidden layers 320, the direction in which the connection weight is updated in the loss backpropagation learning may be from the output layer 330 to the input layer 310 through the hidden layers 320. To process a neural network in a desired direction, one or more processors may use a buffer memory that stores layers or a series of sets of computation data.

The electronic device may define an objective function to measure how close currently set connection weights are to an optimal value, continuously change the connection weights based on a result of the objective function, and iteratively perform the training. For example, the objective function may be a loss function used to calculate (e.g., determine) a loss between an actual output value that is output based on a training input of training data and a predicted value that is expected to be output. The electronic device may update connection weights in a direction that may reduce a value of the loss function.

Although the DNN 300 may be trained to determine live (or real) information or spoofed (or fake) information through a network and derive an optimal result from a final output of an output layer, each intermediate layer included in the network, in addition to the output layer, may also have an ability to discriminate between the live information and the spoofed information in a training process. The electronic device of one or more embodiments may using such a discrimination ability of the intermediate layer to derive a result of whether biometric information is spoofed or not before reaching a final output layer (for example, the output layer 330), thereby reducing the time used for performing operations.

The electronic device of one or more embodiments may use the intermediate layer having the discrimination ability in a step before the DNN 300 derives a final result, thereby improving a spoofing detection speed while minimizing the degradation of accuracy in spoofing detection. In addition, the electronic device of one or more embodiments may also minimize the degradation of accuracy using a result of networks receiving different images as an input to compensate for the degradation of accuracy due to the use of an output of the intermediate layer.

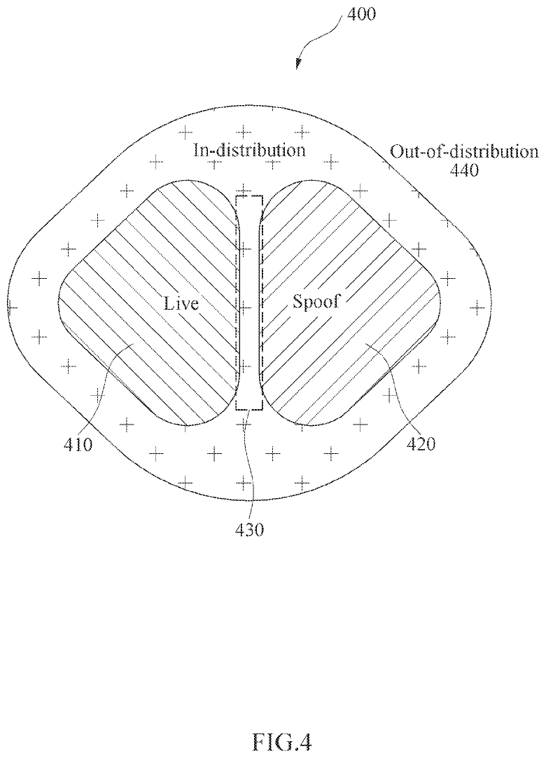

FIG. 4 is a diagram illustrating an example of an area discriminating spoofed information and live information by a neural network. In the example of FIG. 4, illustrated is a datagram 400 including areas 410, 420, 430, and 440 divided according to a distribution of features classified by a neural network.

The neural network may be trained using an unspecified number of live biometric information and spoofed biometric information. A vector generated by the neural network may have embedded feature information of biometric information, which may also be referred to as an embedding vector or a feature vector.

In the feature distribution illustrated in FIG. 4, a first area 410 may be where a feature or feature vector extracted from input data is classified as live information, and a second area 420 may be where a feature or feature vector extracted from the input data is classified as spoofed information.

In addition, a third area 430 disposed between the first area 410 and the second area 420 may be an area that determines a discrimination between the live information and the spoofed information. The third area 430 may be an area that allows some errors to prevent over-fitting for the performance of generalization. The third area 430 may include a threshold range that clearly identifies whether a score (e.g., a first score) corresponding to the input data calculated by the neural network is a score corresponding to the live information or a score corresponding to the spoofed information. For example, the threshold range may be determined based on a first threshold value corresponding to a maximum probability that the first score is determined to correspond to the spoofed information in a probability distribution of the first score, and on a second threshold value corresponding to a minimum probability that the first score is determined to correspond to the live information in the probability distribution of the first score.

The first area 410, the second area 420, and the third area 430 may correspond to an in-distribution area of the feature distribution corresponding to data or feature vectors learned by the neural network.

In addition, a fourth area 440 corresponding to an out-of-distribution (OOD) area of the feature distribution in the datagram 400 may correspond to an area corresponding to unseen data, e.g., features that are not previously learned by the neural network. In this case, the neural network may not readily determine whether a feature included in the fourth area 440 corresponds to the live information or the spoofed information.

For the determination to be made for the fourth area 440, augmentation or generalization may be employed. For example, for better determination to be made for any spoofed fingerprints, it may be desirable for the neural network to determine that the fourth area 440 is an uncertain area.

Most methods of detecting an input corresponding to the fourth area 440 corresponding to the OOD area of the distribution may reinforce a classifier with a knowledge or rejection class for the OOD area of the distribution and formulate a problem, or depend on a specific assumption. However, according to one or more embodiments, a method of processing an input corresponding to the OOD area of the distribution by changing an activation function of the neural network may be employed.

FIG. 5 is a diagram illustrating an example of an activation function applied to each layer of a neural network. Referring to FIG. 5, illustrated is a neural network 500.

The neural network 500 may generate a first intermediate vector by applying a first activation function to first nodes included in a first intermediate layer 520 adjacent to an input layer 510 among a plurality of intermediate layers of the neural network 500. The first activation function may include, as non-limiting example, any one or any combination of any two or more of a step function, a sigmoid function, a hyperbolic tangent function, a ReLU function, and a leaky ReLU function.

The neural network 500 may transfer the first intermediate vector generated by the first intermediate layer 520 to second nodes included in a second intermediate layer 530 adjacent to an output layer 540 among the intermediate layers through propagation, and generate a second intermediate vector by applying a second activation function to the second nodes. The neural network 500 may output an estimated result by applying, to the output layer 540, the second intermediate vector generated in the second intermediate layer 530.

Under a specific assumption, a neural network having one or more intermediate layers may converge on a Gaussian process (GP) in a limitation of infinite width. A Matérn activation function may be used for a new nonlinear neural network that imitates a property induced by a Matérn kernel used in a GP model.

The Matérn activation function may have a similar property to that of an activation function of the GP model. The Matérn activation function may have a local stationary property, along with a limited mean square differential property, that exhibits accurate performance and an uncertainty correcting ability in a Bayesian deep learning task. For example, local stationarity may contribute to correcting the uncertainty in an OOD area.

For example, an activation function (e.g., a second activation function) that is improved from the Matérn activation function derived from the Matérn kernel used in the GP may be used.

The Matérn activation function, or σ(x), derived from the Matérn kernel may be a nonlinear function, which may be represented by Equation 1 below, for example.

$$σ ( x ) = \frac{q}{Γ ( ν + 1 / 2 )} Θ ( x ) {x}^{ν - 1 / 2} exp ( - λ x ) \qquad Equation 1$$

In Equation 1, Γ(⋅) denotes a gamma function, q denotes a constant, and v and A denote hyperparameters.

For example, when v is greater than ½ (v>½), the nonlinear function based on Equation 1 may be smooth and continuous, and continuously differentiable. In contrast, when v<½, the nonlinear function based on Equation 1 may be in the form of a step function that is reduced exponentially, and thus may not be smooth and may correspond to the property of the Matérn kernel.

In addition, Θ(x) denotes a Heaviside step function that allows an output of the activation function to be 0 when an input x is less than 0. In Equation 1, x^{v-1/2} exp(−λx) may correspond to a portion that indicates a shape of the Matérn activation function.

The Matérn activation function σ(x) based on Equation 1 may be improved in terms of stationarity, compared to other activation functions for a Bayesian neural network, and thus may have not a limitation of a multiplier.

In Equation 1, a multiplier

$$\frac{q}{Γ ( ν + 1 / 2 )}$$

may be derived through a complex mathematical development. However, for example, a degree of freedom may increase in a multiplier for white noise that appear in the middle of a logical development or a multiplier used for a Fourier transform, and thus the multiplier of Equation 1 above may be fixed as a constant or may not be fixed according to the mathematical development. That is, the multiplier

$$\frac{q}{Γ ( ν + 1 / 2 )}$$

of Equation 1 may correspond to a sufficiently variable portion.

When the variable multiplier portion is indicated as a constant, dynamics of a neural network may be somewhat fixed by batch normalization and/or a normalization property of a weight. However, when fine-tuning is performed on the neural network, the multiplier portion may be considerably adjusted. When it is not adjusted, a dynamic range of the activation function may not be present between 0 and 1.

Equation 1 may be adjusted to an activation function (e.g., a second activation function) σ(x) that is represented by Equation 2 below, for example, in consideration of the degree of freedom of the multiplier

$$\frac{q}{Γ ( ν + 1 / 2 )}$$

and the hyperparameter of Equation 1 for the neural network.

$$σ ( x ) = {( \frac{eb}{a} )}^{a} {x}^{a} exp ( - bx ) Θ ( x ) \qquad Equation 2$$

In Equation 2, a denotes a first hyperparameter associated with (e.g., corresponding to) an ascending slope of the second activation function, and b denotes a second hyperparameter associated with a descending slope of the second activation function. The hyperparameters a and b may be greater than zero (a, b>0), and be defined by a user.

e denotes Euler number, and x denotes an input to an activation function, for example, an input of second nodes. Θ(x) denotes a Heaviside step function that allows an output of the second activation function to be 0 when the input x is less than 0.

The second activation function σ(x) may be determined by the first hyperparameter a of which the multiplier of the second activation function is associated with the ascending slope of the second activation function and the second hyperparameter b of which the multiplier of the second activation function is associated with the descending slope of the second activation function to fix a peak value (e.g., a peak output value) of the second activation function. The peak value of the second activation function may be fixed to 1, for example, and a dynamic range (e.g., a dynamic range of an output) of the second activation function may be limited to (0, 1). (0, 1) may indicate a value between 0 and 1.

In Equation 2, the multiplier may be limited and normalized such that a maximum value of the activation function becomes 1, and the hyperparameters represented as v and A in Equation 1 may be represented as a and b. Using the second activation function of Equation 2 through such normalization may have the following effects.

For example, in consideration of a dynamic range of a feature vector (or feature) output from a preceding layer according to a characteristic of the neural network 500, fixing and using the dynamic range (0, 1) of the second activation function may stably provide an input to a following layer. In addition, through an input in the stable dynamic range normalized by the second activation function, the neural network 500 may have a fast convergence rate or a fast convergence speed, and thus a processing speed of the neural network 500 may be improved.

Compared to the first activation function (e.g., of Equation 1), the second activation function of Equation 2 may provide an uncertain decision on an input in an OOD area (e.g., the fourth area 440 of FIG. 4), and may thus reduce a probability that the neural network 500 outputs an error for an input in the OOD area.

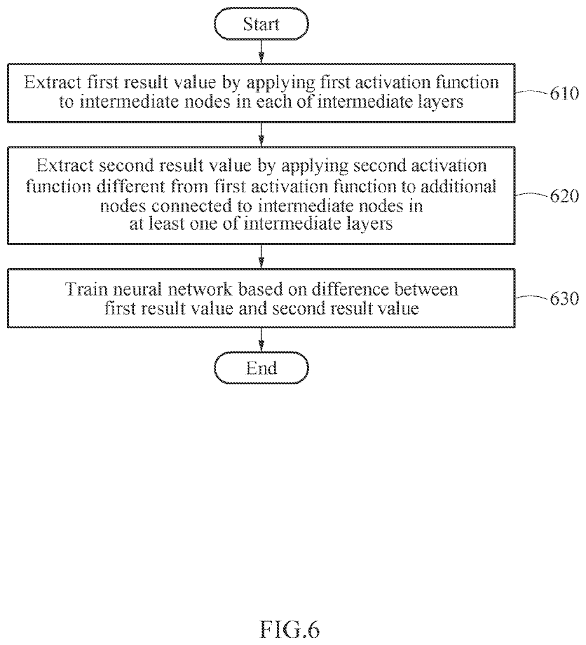

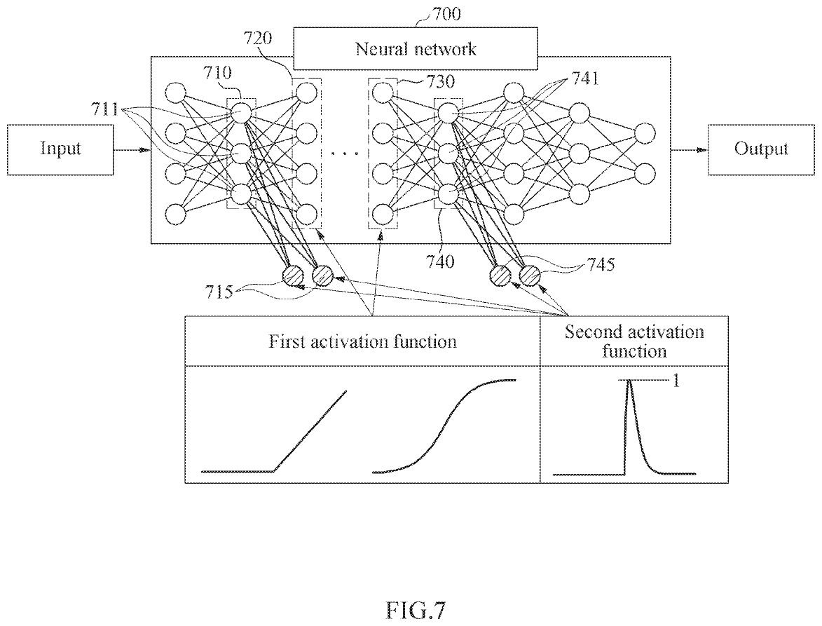

FIG. 6 is a flowchart illustrating an example of a training method of a neural network, and FIG. 7 is a diagram illustrating an example of a training method (e.g., the training method of FIG. 6). The operations of FIG. 6 to be described hereinafter may be performed in sequential order, but not be necessarily performed in sequential order. For example, the order of the operations may be changed, and at least two of the operations may be performed in parallel or simultaneously. Further, one or more of the operations may be omitted, without departing from the spirit and scope of the shown example. One or more blocks of FIG. 6, and combinations of the blocks, may be implemented by special purpose hardware-based computer that perform the specified functions, or combinations of special purpose hardware and instructions, e.g., computer or processor instructions. In addition to the description of FIG. 6 below, the descriptions of FIGS. 1-5 are also applicable to FIG. 6 and are incorporated herein by reference. Thus, the above descriptions may not be repeated here for brevity purposes.

Referring to FIGS. 6 and 7, a training device may train a neural network 700 by performing operations 610 through 630 to be described hereinafter. The training device may be, include, or be included in either one or both of the electronic device 100 of FIG. 1 and the electronic device 1200 of FIG. 12, as a non-limiting example.

In operation 610, the training device may extract a first result value by applying a first activation function to intermediate nodes included in each of a plurality of intermediate layers 720 and/or 730 of the neural network 700. The first activation function may include, as non-limiting examples, any one or any combination of any two or more of a step function, a sigmoid function, a hyperbolic tangent function, a ReLU function, and a leaky ReLU function.

In operation 620, the training device may extract a second result value by applying a second activation function different from the first activation function to additional nodes 715 and/or 745 respectively connected to intermediate nodes 711 and/or 741 respectively included in at least one layer 710 and/or 740 among a plurality of intermediate layers. The number of the additional nodes 715 and/or 745 may be the number corresponding to −1 of the number of the respective intermediate nodes 711 and/or 741 connected to the additional nodes 715 and/or 745, and the additional nodes 715 and/or 745 and the respective intermediate nodes 711 and/or 741 may be fully connected.

The second activation function may be determined by a first hyperparameter of which a multiplier of the second activation function is associated with an ascending slope of the second activation function and a second hyperparameter of which the multiplier is associated with a descending slope of the second activation function, to fix a peak value of the second activation function to 1, for example. For example, the second activation function may be represented as Equation 2 above, in which x denotes an input of additional nodes (e.g., 715 and/or 745), and Θ(x) denotes a Heaviside step function that allows an output of the second activation function to be 0 when the input x is less than 0. A dynamic range of the second activation function may be limited to (0, 1), for example.

In operation 630, the training device may train the neural network 700 based on a difference between the first result value extracted in operation 610 and the second result value extracted in operation 620. The training device may train the neural network 700 such that the difference between the first result value and the second result value is minimized.

The neural network 700 may be trained by connecting the additional nodes 715 and/or 745 corresponding to an additional decision neuron respectively to the layers 710 and/or 740 among the intermediate layers of the neural network 700 and applying the second activation function, and applying a decision loss between the first result value obtained by applying the first activation function and the second result value obtained by applying the second activation function. In this case, designing the additional decision loss by connecting the additional nodes 715 and/or 745 respectively to the layers 710 and/or 740 of the neural network 700 may achieve the same result as a method of directly applying, to the layers 710 and/or 740, a gradient to which the second activation function is applied.

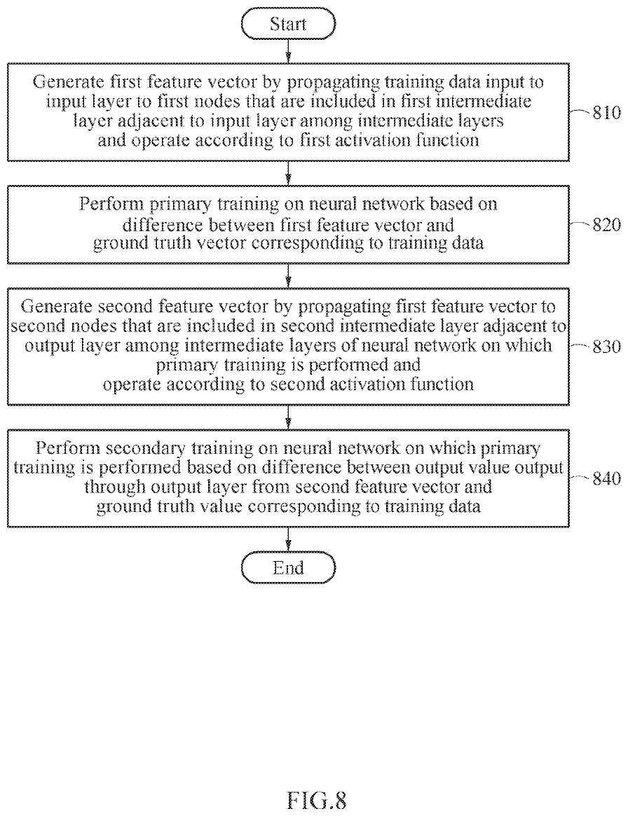

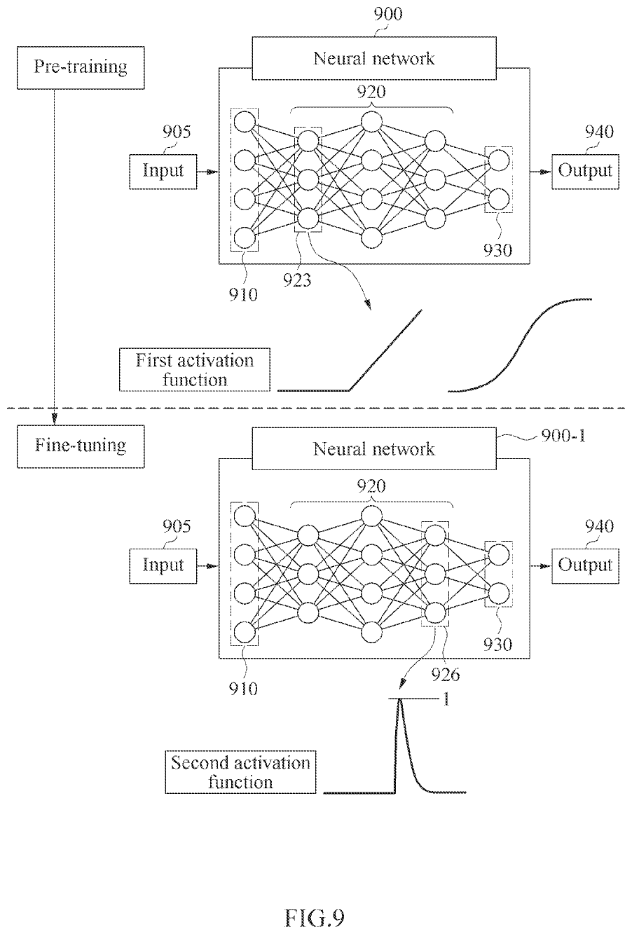

FIG. 8 is a flowchart illustrating an example of a training method of a neural network, and FIG. 9 is a diagram illustrating an example of a training method (e.g., the training method of FIG. 8).

The operations of FIG. 8 to be described hereinafter may be performed in sequential order, but not be necessarily performed in sequential order. For example, the order of the operations may be changed, and at least two of the operations may be performed in parallel or simultaneously. Further, one or more of the operations may be omitted, without departing from the spirit and scope of the shown example. One or more blocks of FIG. 8, and combinations of the blocks, may be implemented by special purpose hardware-based computer that perform the specified functions, or combinations of special purpose hardware and instructions, e.g., computer or processor instructions. In addition to the description of FIG. 8 below, the descriptions of FIGS. 1-7 are also applicable to FIG. 8 and are incorporated herein by reference. Thus, the above descriptions may not be repeated here for brevity purposes.

Referring to FIGS. 8 and 9, a training device may train a neural network 900 by performing operations 810 through 840. In the example of FIG. 9, the neural network 900 illustrated in an upper part above a broken line may be a network trained with a first activation function, and a neural network 900-1 illustrated in a lower part below the broken line may correspond to a network obtained through fine-tuning by changing a portion of the first activation function to a second activation function.

In operation 810, the training device may generate a first feature vector by propagating training data 905 input to an input layer 910 of the neural network 900 to first nodes that operate according to the first activation function and are included in a first intermediate layer 923 adjacent to the input layer 910 among a plurality of intermediate layers 920 of the neural network 900. For example, the first feature vector may be generated by one or more of the first nodes using the first activation function with the training data 905 as an input. The first activation function may include, as non-limiting examples, any one or any combination of any two or more of a step function, a sigmoid function, a hyperbolic tangent function, a ReLU function, and a leaky ReLU function.

In operation 820, the training device may perform primary training on the neural network 900 based on a difference between the first feature vector and a ground truth vector corresponding to the training data 905. The primary training may also be referred to herein as pre-training.

In operation 830, the training device may generate a second feature vector by propagating the first feature vector to second nodes that operate according to the second activation function and are included in a second intermediate layer 926 adjacent to an output layer 930 among the intermediate layers 920 of the neural network 900-1 obtained through the primary training. The second activation function may be represented as Equation 2 above in which x denotes the second feature vector, and Θ(x) denotes a Heaviside step function that allows an output of the second activation function to be 0 when the second feature vector x is less than 0. A dynamic range of the second activation function may be limited to (0, 1), for example.

In operation 840, the training device may perform secondary training on the neural network 900-1 obtained through the primary training, based on a difference between an output value 940 obtained by outputting the second feature vector generated in the second intermediate layer 926 through the output layer 930 and a ground truth value corresponding to the training data 905. The secondary training may also be referred to herein as fine-tuning.

The neural network 900 may output the output value 940 corresponding to a result of propagating the training data 905 in a forward direction, and calculate the difference between the actual output value 940 and the ground truth value corresponding to the training data 905 corresponding to a predicted output of the neural network 900. The training device may train the neural network 900 by propagating the difference between the ground truth value and the output value 940 in a backward direction and adjusting weights of the neural network 900 to minimize the difference.

Even for a general neural network, the training device of one or more embodiments may improve the accuracy of the neural network by performing fine-tuning by applying a second activation function that suggests non-linearity for nodes included in a layer adjacent to an output layer without newly training the neural network for a task.

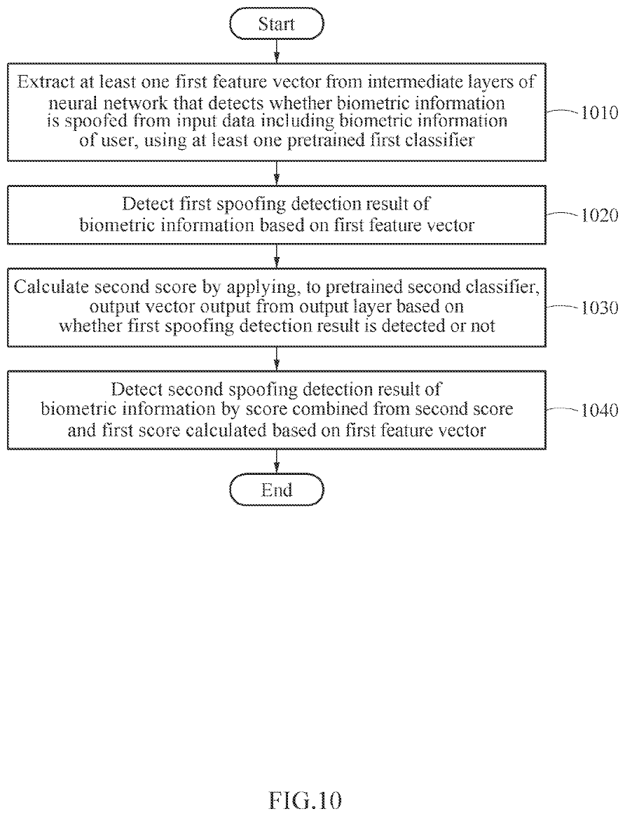

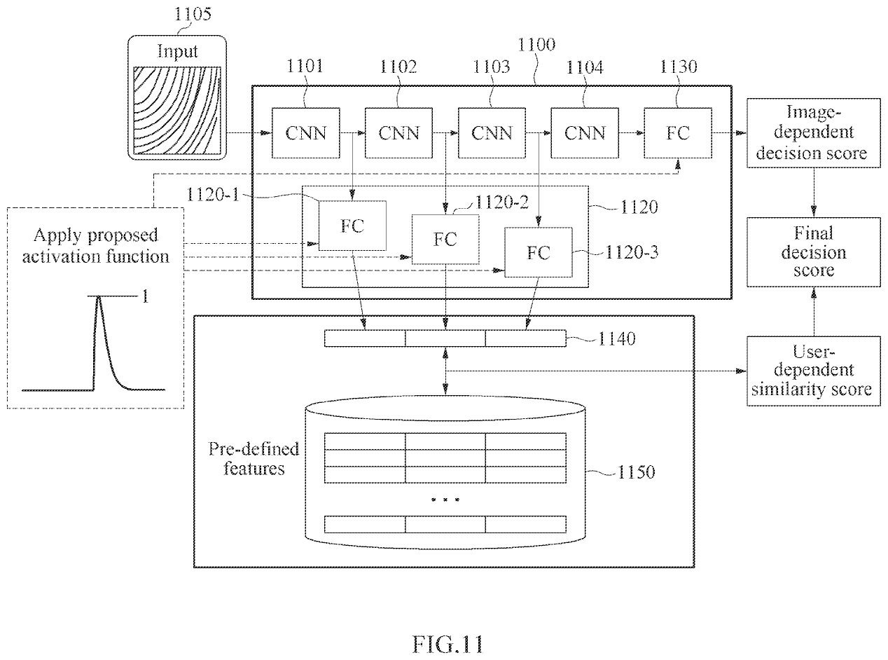

FIG. 10 is a flowchart illustrating an example of a method of detecting whether biometric information is spoofed using a neural network, and FIG. 11 is a diagram illustrating an example of a structure and operation of a neural network (e.g., the neural network of FIG. 10). The operations of FIG. 10 to be described hereinafter may be performed in sequential order, but not be necessarily performed in sequential order. For example, the order of the operations may be changed, and at least two of the operations may be performed in parallel or simultaneously. Further, one or more of the operations may be omitted, without departing from the spirit and scope of the shown example. One or more blocks of FIG. 10, and combinations of the blocks, may be implemented by special purpose hardware-based computer that perform the specified functions, or combinations of special purpose hardware and instructions, e.g., computer or processor instructions. In addition to the description of FIG. 10 below, the descriptions of FIGS. 1-9 are also applicable to FIG. 10 and are incorporated herein by reference. Thus, the above descriptions may not be repeated here for brevity purposes.

Referring to FIGS. 10 and 11, an electronic device may detect whether biometric information is spoofed or not using a neural network 1100 through operations 1010 to 1040. The electronic device may be, include, or be included in either one or both of the electronic device 100 of FIG. 1 and the electronic device 1200 of FIG. 12, as a non-limiting example. The neural network 1100 may be or include, for example, a CNN and/or a DNN, but examples of which are not limited thereto. For example, the neural network 1100 may be trained to detect whether the biometric information is spoofed by applying a second activation function to at least a portion of intermediate layers.

In operation 1010, the electronic device may extract at least one first feature vector from a plurality of intermediate layers 1101, 1102, and 1103 of the neural network 1100 configured to detect whether biometric information of a user is spoofed from input data 1105 including the biometric information of the user, using one or more pre-trained first classifiers 1120. The biometric information may include any one or any combination of any two or more of a fingerprint, an iris, and a face of the user, but examples of the biometric information are not limited thereto. The intermediate layers 1101, 1102, and 1103 may each correspond to a CNN, but examples of which are not limited thereto.

In operation 1010, for example, the electronic device may extract a 1-1 feature vector from a first intermediate layer 1101 among the intermediate layers 1101, 1102, and 1103, using a 1-1 classifier 1120-1 among the first classifiers 1120. The electronic device may extract a 1-2 feature vector from a second intermediate layer 1102 following the first intermediate layer 1101, using a 1-2 classifier 1120-2 among the first classifiers 1120. The electronic device may extract a first feature vector 1140 in which the 1-1 feature vector and the 1-2 feature vector are combined.

Alternatively or additionally, in operation 1010, the electronic device may extract a 1-3 feature vector from a third intermediate layer 1103 following the second intermediate layer 1102, using a 1-3 classifier 1120-3 among the first classifiers 1120. The electronic device may extract the first feature vector 1140 in which the 1-1 feature vector, the 1-2 feature vector, and the 1-3 feature vector are combined.

In operation 1020, the electronic device may detect a first spoofing detection result of the biometric information based on the first feature vector 1140 obtained in operation 1010. For example, the electronic device may calculate a first score based on a similarity between at least one of a registered feature vector or a spoofing feature vector that is stored in a DB 1150 and the first feature vector 1140 obtained in operation 1010 or the feature vector 1140 combined in operation 1010. The similarity used herein may refer to an indicator that indicates how close the input data 1105 is to live (and/or real) biometric information, and a higher similarity may indicate a higher probability of being the live (and/or real) biometric information (e.g., a fingerprint or iris).

The first score may also be referred to as a user-dependent similarity score in that it is determined by a result obtained through training corresponding to the user. The electronic device may classify the first score into a score determined as spoofed information or a score determined as live information, using the first classifiers 1120. The electronic device of one or more embodiments may calculate the first score based on a ratio of each similarity using in-distribution data such as the registered feature vector and the spoofing feature vector that are stored in the DB 1150 and may thus achieve robustness in determining spoofing.

For example, when the first score corresponds to a feature in an area (e.g., the first area 410 and/or the second area 420 of FIG. 4) that determines whether the biometric information is included in a range determined to be live information or in a range determined to be spoofed information, the electronic device may determine the first spoofing detection result immediately by the first score (e.g., determine the first spoofing detection result without deriving an output vector using an output layer 1104). The electronic device may immediately make an early decision (ED) on the input data 1105 to determine whether it is the live information or the spoofed information. In contrast, when the first score corresponds to a feature in an area (e.g., the third area 430 and/or the fourth area 440 of FIG. 4) that does not clearly determine which one the biometric information belongs, the electronic device may not immediately determine the first spoofing detection result by the first score but instead may determine a spoofing detection result (e.g., a second spoofing detection result) through a combination of the first score and a second score. As a non-limiting example, when the first score is greater than or equal to a first threshold value for determining the first spoofing detection result, the electronic device may immediately determine the input data 1105 to be the live information, and when the first score is less than or equal to a second threshold value (that is less than the first threshold value) for determining the first spoofing detection result, the electronic device may immediately determine the input data 1105 to be the spoofed information. However, in the non-limiting example, when the first score is less than the first threshold value and greater than the second threshold value (e.g., within a predetermined threshold value range), the electronic device may not immediately determine the first spoofing detection result by the first score but instead may determine the second spoofing detection result.

Unlike a general DNN classifier provided in an end-to-end structure, the first classifiers 1120 of one or more embodiments may classify whether biometric information is spoofed from feature vectors extracted from the intermediate layers 1101, 1102, and 1103 of the neural network 1100 during a network inference from the input data 1105 including the biometric information. For example, the electronic device may of one or more embodiments may classify whether biometric information is spoofed from feature vectors extracted from the intermediate layers 1101, 1102, and 1103 without deriving an output vector using the output layer 1104. The first classifiers 1120 may each be a classifier trained to classify an input image based on feature vectors. The first classifiers 1120 may be configured by a shallow DNN with less computation amount than a DNN, and may quickly detect (or determine) a first spoofing detection result without a speed degradation because an overhead is small due to an early decision in an intermediate layer.

When the first spoofing detection result is detected or determined through the first classifiers 1120 that perform the early decision before the output vector is derived from the output layer 1104, the electronic device may immediately detect or determine a spoofing detection result without using the output vector.

When determining whether the biometric information is spoofed (i.e., detecting or determining a spoofing detection result), an accuracy of the determination and a speed of the determination may be in a trade-off relationship. For fast determination, the electronic device may sequentially use the first classifiers 1120, but immediately use the first spoofing detection result when a detection confidence of the first classifiers 1120 is high, and determine whether the biometric information is spoofed (or a second spoofing detection result) also using the second score calculated from the output vector by a second classifier 1130 when the detection confidence is low.

In operation 1030, the electronic device may calculate the second score by applying, to the pre-trained second classifier 1130, the output vector output from the output layer 1104 based on the first spoofing detection result that is detected in operation 1020. The second score may also be referred to as an image-dependent decision score in that it is determined based on an image. When determining whether the biometric information is spoofed using only the second score, there may be a high error occurrence probability due to non-stationarity of unseen data, such as, for example, the fourth area 440 of FIG. 4. Thus, the electronic device may determine whether the biometric information is spoofed (e.g., the second spoofing detection result) using both the first score and the second score.

For example, when the first spoofing detection result is detected by the first score, the electronic device may terminate operations without performing operation 1030. However, when a feature corresponding to the first score is not clearly determined to be the live information or the spoofed information as it is included in the third area 430 and/or the fourth area 440, the electronic device may not immediately determine whether the biometric information is spoofed by the first score. When whether the biometric information is spoofed is not immediately determined by the first score, the electronic device may determine whether the biometric information is spoofed (or the second spoofing detection result) using the second score calculated from the output vector together with the first score calculated in operation 1020.

In operation 1030, either one or both of the first classifiers 1120 and the second classifier 1130 may be trained by an activation function that is determined by a first hyperparameter of which a multiplier of the activation function is associated with an ascending slope of the activation function and a second hyperparameter of which the multiplier is associated with a descending slope of the activation function to fix a peak value of the activation function for the neural network 1100. The first classifiers 1120 and the second classifier 1130 may be configured by a fully connected (FC) layer, for example, but are not limited thereto. A dynamic range of the activation function may be limited to (0, 1), for example. The activation function may be represented as Equation 2 above, for example. In Equation 2, x denotes the input data 1105, and Θ(x) denotes a Heaviside step function that allows an output of the activation function to be 0 when the input data x is less than 0.

In operation 1040, the electronic device may secondly detect whether the biometric information is spoofed, e.g., determine the second spoofing detection result, by a score in which the first score calculated based on the first feature vector and the second score are combined. For example, the electronic device may calculate the combined score through a weighted sum of the first score and the second score. When the combined score is greater than a threshold value for determining the second spoofing detection result, the electronic device may determine the input data 1105 to be the live information. In contrast, when the combined score is less than or equal to the threshold value for determining the second spoofing detection result, the electronic device may determine the input data 1105 to be the spoofed information. The electronic device may determine the second spoofing detection result by a result of determining the input data 1105.

In the electronic device that detects whether biometric information is spoofed, an OOD input corresponding to spoofed information may occur frequently. Although the electronic device needs to stably determine the OOD input corresponding to the spoofed information to be the spoofed information, the electronic device may have an overconfidence error as a neural network is overconfident as if it is trained even though the OOD input is unseen data that is not trained before. Thus, when the OOD input is applied to the neural network, unstable determination (or “not decided”) on the OOD input may be better than false determination on spoofing.

Applying the second activation function to the neural network may increase uncertainty of an output in response to the OOD input.

The electronic device of one or more embodiments may reduce an error by outputting a final decision score using, along with the second score, the first score obtained by comparing a similarity between the input data 1105 including an image generated at an authentication attempt and a registered feature vector and a spoofing feature vector that are stored in advance in the DB 1150.

For example, when the OOD input is input to the neural network, the first score may be calculated as a reasonable score because it is robust in similarity calculation based on the method described above. However, with the second score calculated only using the output of the neural network 1100, there may be a high probability of an overconfidence error occurring, and thus a decision score to be finally output from the neural network 1100 may also have more errors.

In such a situation, by applying, to the neural network 1100, the second activation function to which uncertainty is granted, the electronic device of one or more embodiments may prevent the overconfidence error from occurring in response to the OOD input, and contribution of the first score may increase. Thus, fewer errors may occur in the final decision score.

FIG. 12 is a diagram illustrating an example of an electronic device configured to detect whether biometric information is spoofed using a neural network. Referring to FIG. 12, an electronic device 1200 may include a sensor 1210 (e.g., one or more sensors), a processor 1230 (e.g., one or more processors), an output device 1250, and a memory 1270 (e.g., one or more memories). The sensor 1210, the processor 1230, the output device 1250, and the memory 1270 may connected to one another through a communication bus 1205.

The electronic device 1200 may be, include, or be included in a mobile device (e.g., a mobile phone, a smartphone, a personal digital assistant (PDA), a netbook, a tablet computer, a laptop computer, etc.), a wearable device (e.g., a smartwatch, a smart band, smart eyeglasses, etc.), a computing device (e.g., a desktop, a server, etc.), a home appliance (e.g., a television (TV), a smart TV, a refrigerator, etc.), a security device (e.g., a door lock, etc.), a medical device, a robot, an Internet of things (IoT) device, and/or a smart vehicle, but is not limited thereto. For example, the electronic device 1200 may be one of various types of devices.

The sensor 1210 may capture input data including biometric information of a user. The biometric information of the user may include, as non-limiting examples, an iris, a fingerprint, and a face of the user. The sensor 1210 may include, as non-limiting examples, an ultrasonic fingerprint sensor, an optical fingerprint sensor, a capacitive fingerprint sensor, a depth sensor, an iris sensor, and/or an image sensor, and any one or at least two of which may be used as the sensor 1210. The biometric information sensed by the sensor 1210 may be, for example, the input fingerprint image 115 of FIG. 1, or an iris image or a face image.

The processor 1230 may extract at least one first feature vector from a plurality of intermediate layers of a neural network that detects whether the biometric information is spoofed or not from the input data, using one or more pre-trained first classifiers. The processor 1230 may detect first whether the biometric information is spoofed, i.e., determine a first spoofing detection result, based on the first feature vector. The processor 1230 may calculate a second score by applying, to a pre-trained second classifier, an output vector output from an output layer based on whether the first spoofing detection result is detected. The processor 1230 may detect second whether the biometric information is spoofed, i.e., determine a second spoofing detection result, based on a score in which the second score and the first score calculated based on the first feature vector are combined. In this case, at least one of the first classifiers or the second classifier may be trained based on an activation function that is determined by a first hyperparameter of which a multiplier of the activation function is associated with an ascending slope of the activation function and a second hyperparameter of which the multiplier is associated with a descending slope of the activation function to fix a peak value of the activation function for the neural network. The activation function, or σ(x), may be represented as Equation 2 above. In Equation 2, x denotes an input of additional nodes, and Θ(x) denotes a Heaviside step function that allows an output of the activation function to be 0 when the input x of the additional nodes is less than 0.

The processor 1230 may execute executable instructions included in the memory 1270. The instructions, when executed by the processor 1230, may configure the processor 1230 to control the electronic device 1200. A code of the instructions executed by the processor 1230 may be stored in the memory 1270.

The output device 1250 may output at least one of the first spoofing detection result and the second spoofing detection result that are detected by the processor 1230.

The memory 1270 may store the input data captured by the sensor 1210. The memory 1270 may store the first feature vector, the first score, and/or the second score extracted by the processor 1230. The memory 1270 may store an output vector. The memory 1250 may store the first spoofing detection result and/or the second spoofing detection result that is detected by the processor 1230.

The memory 1270 may store various sets of information generated during the processing performed by the processor 1230. In addition, the memory 1270 may store various sets of data and programs. The memory 1270 may include a volatile memory or a nonvolatile memory. The memory 1270 may have a storage medium of a massive capacity, such as, for example, a hard disk, to store various sets of data.

In addition, the processor 1230 may perform any one, combination, or all of the operations and methods described above with reference to FIGS. 1 through 11. The processor 1230 may be a physically structured hardware-implemented electronic device for executing desired operations. The desired operations may include, for example, instructions included in a program. The electronic device 1200 implemented as hardware may include, as non-limiting examples, a microprocessor, a central processing unit (CPU), a graphics processing unit (GPU), a processor core, a multi-core processor, a multiprocessor, an application-specific integrated circuit (ASIC), a field-programmable gate array (FPGA), and/or a neural processing unit (NPU).

The electronic devices, the training devices, sensors, processors, output devices, memories, communication buses, electronic device 100, sensor 110, electronic device 1200, sensor 1210, processor 1230, output device 1250, memory 1270, communication bus 1205, and other devices, apparatuses, units, modules, and components described herein with respect to FIG. 1-12 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-12 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. A processor-implemented method with a neural network, the method comprising:
generating a first intermediate vector by applying a first activation function to first nodes in a first intermediate layer adjacent to an input layer among intermediate layers of the neural network;
transferring the first intermediate vector to second nodes in a second intermediate layer adjacent to an output layer among the intermediate layers;
generating a second intermediate vector by applying a second activation function to the second nodes; and
applying the second intermediate vector to an output layer of the neural network,
wherein the second activation function is determined by a first hyperparameter of which a multiplier of the second activation function is associated with an ascending slope of the second activation function and a second hyperparameter of which the multiplier is associated with a descending slope of the second activation function to fix a peak value of the second activation function.

2. The method of claim 1, wherein a dynamic range of the second activation function is from a value of 0 to a value of 1.

3. The method of claim 1,
wherein the second activation function is represented as σ(x) and is represented by the following equation:
$$σ ( x ) = {( \frac{eb}{a} )}^{a} {x}^{a} exp ( - bx ) Θ ( x ) ,$$
wherein a denotes the first hyperparameter associated with the ascending slope of the second activation function, b denotes the second hyperparameter associated with the descending slope of the second activation function, e denotes Euler's number, x denotes an input of the second nodes, and Θ(x) denotes a Heaviside step function that allows an output of the second activation function to be 0 when x is less than 0.

4. The method of claim 1, wherein the first activation function comprises any one or any combination of any two or more of a step function, a sigmoid function, a hyperbolic tangent function, a rectified linear unit (ReLU) function, and a leaky ReLU function.

5. The method of claim 1, wherein the neural network comprises any one or any combination of any two or more of a convolutional neural network (CNN), a deep neural network (DNN), and a recurrent neural network (RNN).

6. The method of claim 1, wherein
the neural network is a trained neural network, and
the training of the neural network comprises:
extracting a first result value by applying the first activation function to intermediate nodes comprised in each of the intermediate layers;
extracting a second result value by applying the second activation to additional nodes connected to intermediate nodes in one or more of the intermediate layers; and
training the neural network based on a difference between the first result value and the second result value.

7. The method of claim 1,
wherein the first intermediate vector is generated based on training data input, and
further comprising:
performing primary training on the neural network based on a difference between the first intermediate vector and a ground truth vector corresponding to the training data; and
performing the secondary training on the primary trained neural network based on a difference between an output value output through the output layer from the second intermediate vector and a ground truth value corresponding to the training data.

8. The method of claim 1, further comprising:
detecting a first spoofing detection result of biometric information by determining a first score based on the first intermediate vector;
determining, in response to the first spoofing detection result being detected, a second score based on a result of the applying of the second intermediate vector to the output layer; and
detecting a second spoofing detection result of the biometric information by a score in which the first score and the second score are combined.

9. A non-transitory computer-readable storage medium storing instructions that, when executed by one or more processors, configure the one or more processors to perform the method of claim 1.

10. A processor-implemented method with a neural network, the method comprising:
extracting a first result value by applying a first activation function to intermediate nodes comprised in each of intermediate layers of the neural network;
extracting a second result value by applying a second activation function different from the first activation function to additional nodes connected to intermediate nodes in one or more of the intermediate layers; and
training the neural network based on a difference between the first result value and the second result value.

11. The method of claim 10, wherein the second activation function is determined by a first hyperparameter of which a multiplier of the second activation function is associated with an ascending slope of the second activation function and a second hyperparameter of which the multiplier is associated with a descending slope of the second activation function to fix a peak value of the second activation function.

12. The method of claim 10, wherein
a total number of the additional nodes is one less than a total number of the intermediate nodes, and
the additional nodes and the intermediate nodes are fully connected.

13. The method of claim 10, wherein the second activation function is represented as σ(x) and is represented by the following equation:
$$σ ( x ) = {( \frac{eb}{a} )}^{a} {x}^{a} exp ( - bx ) Θ ( x ) ,$$
wherein a denotes a first hyperparameter associated with an ascending slope of the second activation function, b denotes a second hyperparameter associated with a descending slope of the second activation function, e denotes Euler's number, x denotes an input of the additional nodes, and Θ(x) denotes a Heaviside step function that allows an output of the second activation function to be 0 when x is less than 0.

14. The method of claim 10, wherein a dynamic range of the second activation function is from a value of 0 to a value of 1.

15. The method of claim 10, wherein the first activation function comprises any one or any combination of any two or more of a step function, a sigmoid function, a hyperbolic tangent function, a rectified linear unit (ReLU) function, and a leaky ReLU function.

16. A processor-implemented method with a neural network, the method comprising:
generating a first feature vector by propagating training data input to an input layer of the neural network to first nodes that are included in a first intermediate layer adjacent to the input layer among intermediate layers of the neural network and that operate according to a first activation function;
performing primary training on the neural network based on a difference between the first feature vector and a ground truth vector corresponding to the training data;
generating a second feature vector by propagating the first feature vector to second nodes that are included in a second intermediate layer adjacent to an output layer among the intermediate layers of the primary trained neural network; and
performing secondary training on the primary trained neural network based on a difference between an output value output through the output layer from the second feature vector and a ground truth value corresponding to the training data.

17. The method of claim 16, wherein the second activation function is determined by a first hyperparameter of which a multiplier of the second activation function is associated with an ascending slope of the second activation function and a second hyperparameter of which the multiplier is associated with a descending slope of the second activation function to fix a peak value of the second activation function.

18. The method of claim 16, wherein the second activation function is represented as σ(x) and is represented by the following equation:
$$σ ( x ) = {( \frac{eb}{a} )}^{a} {x}^{a} exp ( - bx ) Θ ( x ) ,$$
wherein a denotes a first hyperparameter associated with an ascending slope of the second activation function, b denotes a second hyperparameter associated with a descending slope of the second activation function, e denotes Euler's number, x denotes the second feature vector, and Θ(x) denotes a Heaviside step function that allows an output of the second activation function to be 0 when x is less than 0.

19. The method of claim 16, wherein a dynamic range of the second activation function is from a value of 0 to a value of 1.

20. The method of claim 16, wherein the first activation function comprises any one or any combination of any two or more of a step function, a sigmoid function, a hyperbolic tangent function, a rectified linear unit (ReLU) function, and a leaky ReLU function.

21. A processor-implemented method with a neural network, the method comprising:
extracting one or more first feature vectors from a plurality of intermediate layers of the neural network that detects whether biometric information is spoofed from input data comprising the biometric information of a user, using one or more pre-trained first classifiers;
detecting a first spoofing detection result of the biometric information by determining a first score based on the one or more first feature vectors;
determining, in response to the first spoofing detection result being detected, a second score by applying, to a pre-trained second classifier, an output vector output from an output layer of the neural network; and
detecting a second spoofing detection result of the biometric information by a score in which the first score and the second score are combined,
wherein either one or both of the first classifiers and the second classifier is trained by an activation function that is determined by a first hyperparameter of which a multiplier of the activation function is associated with an ascending slope of the activation function and a second hyperparameter of which the multiplier is associated with a descending slope of the activation function to fix a peak value of the activation function for the neural network.

22. The method of claim 21, wherein a dynamic range of the activation function is from a value of 0 to a value of 1.

23. The method of claim 21, wherein the activation function is represented as σ(x) and is represented by the following equation:
$$σ ( x ) = {( \frac{eb}{a} )}^{a} {x}^{a} exp ( - bx ) Θ ( x ) ,$$
wherein a denotes the first hyperparameter associated with the ascending slope of the activation function, b denotes the second hyperparameter associated with the descending slope of the activation function, e denotes Euler's number, x denotes the input data, and Θ(x) denotes a Heaviside step function that allows an output of the activation function to be 0 when x is less than 0.

24. The method of claim 21, wherein the extracting of the one or more first feature vectors comprises:
extracting a feature vector from a first intermediate layer among the intermediate layers using a classifier among the first classifiers;
extracting another feature vector from a second intermediate layer following the first intermediate layer using another classifier among the first classifiers; and
extracting a combined feature vector in which the feature vector and the other feature vector are combined.

25. The method of claim 24, wherein the detecting of the first spoofing detection result of the biometric information comprises:
determining the first score based on a similarity between the combined feature vector and either one or both of a registered feature vector and a spoofed feature vector that is provided in advance; and
classifying the first score into a score determined to be spoofed information or a score determined to be ground truth information, using the first classifiers.

26. The method of claim 21, wherein the biometric information comprises any one or any combination of any two or more of a fingerprint, an iris, and a face of the user.

27. An electronic device with a neural network, the electronic device comprising:
a sensor configured to capture input data comprising biometric information of a user;
one or more processors configured to:
extract one or more first feature vectors from a plurality of intermediate layers of the neural network configured to detect whether biometric information is spoofed from the input data, using one or more pre-trained first classifiers;
detect a first spoofing detection result of the biometric information by determining a first score based on the one or more first feature vectors;
determine, in response to the first spoofing detection result being detected, a second score by applying an output vector output from an output layer of the neural network to a pre-trained second classifier; and
detect a second spoofing detection result of the biometric information by a score in which the first score and the second score are combined; and
an output device configured to output either one or both of the first spoofing detection result and the second spoofing detection result,
wherein either one or both of the first classifiers and the second classifier is trained based on an activation function that is determined by a first hyperparameter of which a multiplier of the activation function is associated with an ascending slope of the activation function and a second hyperparameter of which the multiplier is associated with a descending slope of the activation function to fix a peak value of the activation function for the neural network.

28. The electronic device of claim 27,
wherein the activation function is represented as σ(x) and is represented by the following equation:
$$σ ( x ) = {( \frac{eb}{a} )}^{a} {x}^{a} exp ( - bx ) Θ ( x ) ,$$
wherein a denotes the first hyperparameter associated with the ascending slope of the activation function, b denotes the second hyperparameter associated with the descending slope of the activation function, e denotes Euler's number, x denotes an input of additional nodes, and Θ(x) denotes a Heaviside step function that allows an output of the activation function to be 0 when x is less than 0.

29. A processor-implemented method with a neural network, the method comprising:
performing first spoofing detection by determining a first score based on one or more first feature vectors generated using a first intermediate layer of the neural network based on input data;
determining whether to perform second spoofing detection, based on the first score; and
in response to determining to perform the second spoofing detection,
determining a second score based on an output vector generated by an output layer of the neural network based on the one or more first feature vectors; and
performing the second spoofing detection based on a score in which the first score and the second score are combined.

30. The method of claim 29, wherein
the one or more first feature vectors are generated by applying input data to a first activation function of the first intermediate layer, and
the determining of the second score comprises:
generating one or more second feature vectors by applying the one or more first feature vectors to a second activation function of a second intermediate layer, wherein one or more intermediate layers are disposed between the first intermediate layer and the second intermediate layer; and
generating the output vector based on the one or more second feature vectors, using the output layer.

31. The method of claim 30, wherein a dynamic range of an output of the second activation function is less than the first activation function.

32. The method of claim 29, wherein the determining of whether to perform the second spoofing detection comprises:
determining not to perform the second spoofing detection in response to the first score being within a predetermined threshold value range; and
determining to perform the second spoofing detection in response to the first score being outside the predetermined threshold value range.
